(19) United States
(12) Patent Application Publication
(10) Pub. No.: US 2008/0061254 A1
(43) Pub. Date: Mar. 13, 2008

(54) Utilizing reflective substrates and patterned filters for security and authentication

(76) Inventors: Julie E. Fouquet, Portola Valley, CA (US); Richard E. Haven, Sunnyvale, CA (US); Shalini Venkatesh, Santa Clara, CA (US); Carl Chang, Los Altos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/519,472

(22) Filed: Sep. 12, 2006

(51) Int. Cl. G06K 11/00

(52) U.S. Cl. 250/556

(57) ABSTRACT

In accordance with the invention, a sensor system includes an illumination source for outputting illumination. Furthermore, the sensor system also includes an imager for receiving the illumination reflected from a target utilized for authentication. It is noted that the target includes a patterned filter and a reflective substrate.

### BACKGROUND

Within the marketplace, there are those that produce and distribute fraudulent copies of original existing products. This type of product fraud, which is a widespread problem, can result in a loss of potential revenue for companies that produce the original existing products. Furthermore, the reputation of the company that produces the original existing product can be hurt when consumers are unaware that they are purchasing a fraudulent copy of lower quality.

One conventional solution for indicating an authentic product to a consumer has been utilized for purchasing software. Specifically, consumers purchasing software are able to receive authentication corresponding to their product via the Internet. However, this type of software authentication does not typically apply to products that do not relate to, or interface with, computers.

Another conventional solution for indicating an authentic product to a consumer is by affixing a holographic sticker to the product. However, this solution has had limited access since the stickers are relatively easy to copy, and are difficult for consumers to differentiate between an authentic one and a copy.

Therefore, it is desirable to address one or more of the above issues.

### SUMMARY

In accordance with the invention, a sensor system includes an illumination source for outputting illumination. Furthermore, the sensor system also includes an imager for receiving the illumination reflected from a target utilized for authentication. It is noted that the target includes a patterned filter and a reflective substrate.

### BRIEF DESCRIPTION OF THE DRAWINGS

FIG. 1 is a block diagram of an exemplary system in accordance with various embodiments of the invention.

FIG. 2 is a block diagram of an exemplary product including an affixed authentication target in accordance with various embodiments of the invention.

FIG. 3 is a plan view of an exemplary patterned filter in accordance with various embodiments of the invention.

FIG. 4 is a plan view of another exemplary patterned filter in accordance with various embodiments of the invention.

FIG. 5 is a plan view of an exemplary portion of an imager filter in accordance with various embodiments of the invention.

FIG. 6 is a plan view of another exemplary portion of an imager filter in accordance with various embodiments of the invention.

FIG. 7 is a plan view of two exemplary sequential images in accordance with various embodiments of the invention.

FIG. 8 is a flow diagram of an exemplary method in accordance with various embodiments of the invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

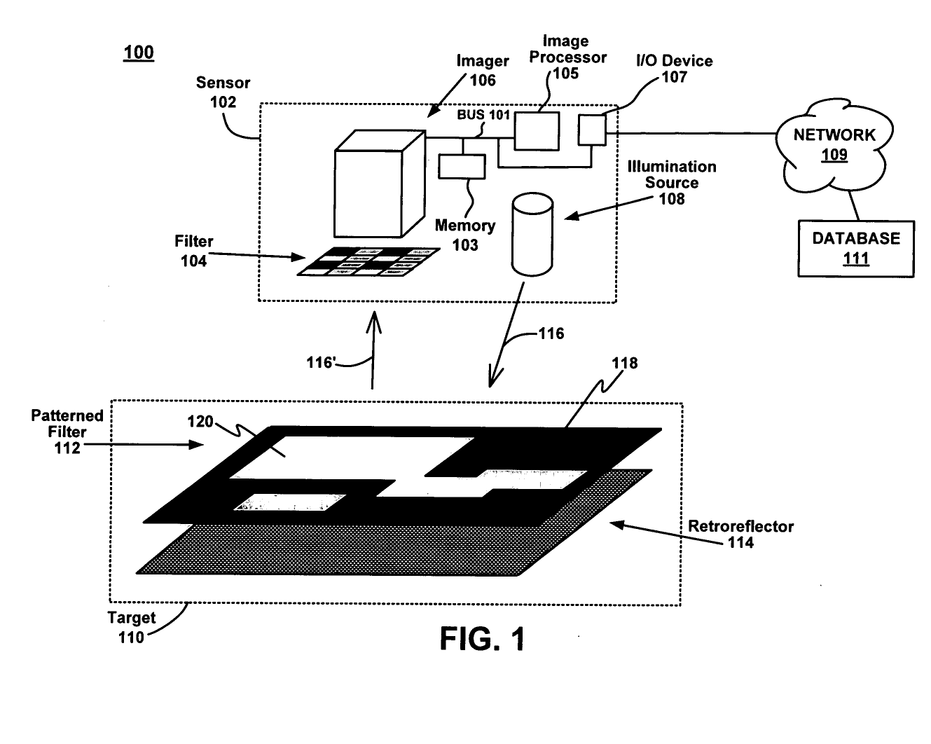

FIG. 1 is a block diagram of an exemplary system 100 for authentication and/or security purposes in accordance with various embodiments of the invention. System 100 can include two parts, a sensor system 102 and a target 110. The target 110 can be implemented as an authentication seal when affixed to a product or an object (not shown). It is noted that the target 110 can also be a security device for validating identity. Within system 100, confirmation of the authenticity of the target 110 can be performed by the sensor system 102. The sensor system 102 can be implemented in a wide variety of ways. For example, sensor 102 can be implemented as a small device, e.g., on the order of 1 cubic centimeter (cm³), or it can be attached to or incorporated with a larger device, such as, a mobile telephone, a portable computing device, and the like. As such, users of these types of devices could then check for themselves whether a product or object is authentic or not.

The target (or label) 110 can be constructed or fabricated by covering a reflective substrate 114 with a patterned filter 112. In various embodiments, the reflective substrate 114 can be implemented in a wide variety of ways. For example, the reflective substrate 114 can be, but is not limited to, a substrate that substantially reflects light or illumination (as opposed to a substrate that substantially allows light or illumination to pass through it), a retroreflector (as shown in FIG. 1), any type of mirror, any reflective material, any reflective paint, any white colored paint, any light colored paint, any material that reflects light at one of more wavelengths of interest, any material that scatters light at one or more wavelengths of interest, or any combination thereof. It is understood that a functional characteristic of a retroreflector is that it is able to reflect light back in predominately (or substantially) the same direction that the light was initially received. Furthermore, a retroreflector can operate over a wide range of incoming angles. Since a retroreflector is a passive device, it does not consume any energy while operating as reflective substrate 114. Moreover, a retroreflector is fairly low cost to purchase and when used as reflective substrate 114, it can contribute to the affordability of reflective substrate 114 and system 100. While preventing fraud, it is desirable for the system to be low cost and reliable. It is appreciated that retroreflectors are well known by those of ordinary skill in the art.

The patterned filter 112 of FIG. 1 can have one or more distinct regions (e.g., 118) that substantially block illumination 116 of a particular wavelength (λ₁). Additionally, the patterned filter 112 can include one or more distinct regions (e.g., 120) that allow illumination 116 of wavelength (λ₁) to pass through it. The wavelength (λ₁) of illumination 116 can be implemented in a wide variety of ways. For example, the wavelength (λ₁) of illumination 116 can be substantially equal to a wavelength that is within or near the infrared spectrum, but is not limited to such.

It is appreciated that patterned filter 112 can include one or more patterns on top of reflective substrate 114 that each selectively and substantially block a particular wavelength of illumination. Additionally, the sensor 102 can have an illumination source or sources 108 at these different wavelengths that can be selectively turned on. As such, depending on which illumination source 108 is turned on, the imager 106 receives a different image pattern.

For example, within FIG. 1, if you had three illumination sources 108 that each output illumination at a different wavelength, the patterned filter 112 could be implemented with different regions that correspond to each of those three wavelengths. It is understood that each of the three illumination sources 108 could be activated in a series manner, or in different combinations. As such, different images could be provided to the imager 106. In order for the sensor 102 to be able to authenticate target 110, it is desirable that the sensor 102 know the order or manner in which the three illumination sources 108 are being activated.

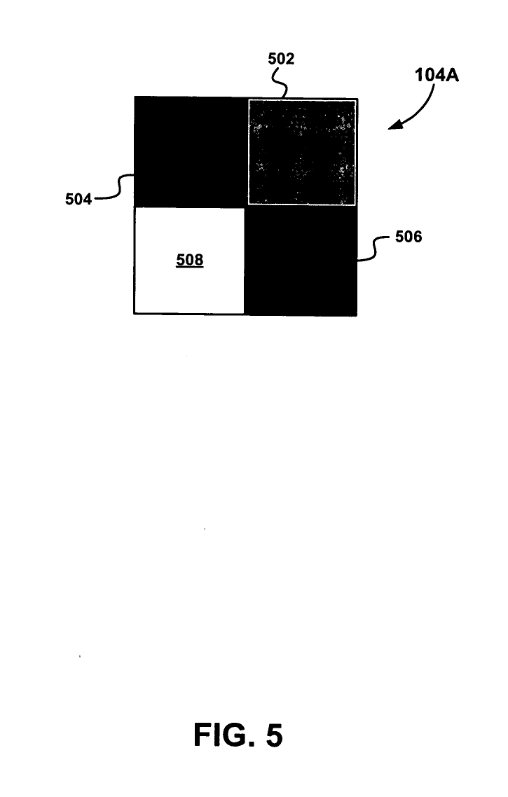

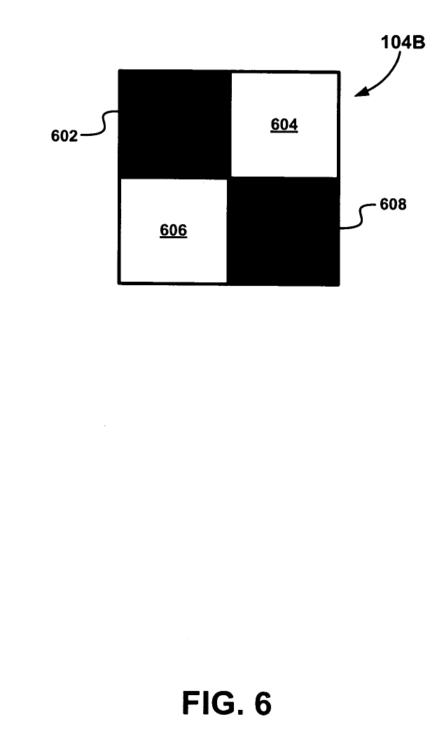

An optional imager filter 104 can be utilized when multiple wavelengths are being utilized in combination with target 110. In this manner, the imager 106 can delineate the differences in wavelength within the images that it receives. However, if the patterned filter 112 just involves the substantial blocking of a single illumination wavelength, the imager filter 104 can be optional. Understand that filter 104 can also provide the functionality of filtering out other specular light reflections that are unrelated to the illumination 116′ reflected from target 110. It is understood that the filter 104 for imager 106 can be a patterned filtered applied over the pixel array of imager 106. It may be desirable that parts of the pixel array be able to detect light at wavelength λ₁. The imager's filter 104 can have a regular pattern, commonly repeating a 2×2 pixel pattern. FIGS. 5 and 6 illustrate a couple of exemplary 2×2 pixel patterns that can be utilized in accordance with various embodiments of the invention. In various embodiments, it is understood that the imager filter 104 can be implemented with any type of pattern and can be implemented to filter one or more illumination wavelengths.

Optionally, the patterned filter 112 of FIG. 1 may be implemented to contain a pattern/design (e.g., logo, picture, image, alphanumeric, etc.) that is colored in the visible spectrum. However, if the patterned filter 112 is implemented in this manner, note that the visible spectrum pattern/design typically should be transparent to illumination 116 at wavelength (λ₁). Note that the visible spectrum pattern/design of the patterned filter 112 can be transparent to one or more illumination wavelengths. In accordance with another embodiment of the invention, another optional patterned filter layer (not shown) that may contain a pattern/design that is colored in the visible spectrum can be implemented to cover the patterned filter 112 of target 110. It is appreciated that the optional patterned filter typically should be transparent to illumination 116 at wavelength (λ₁). Note that the optional patterned filter can be transparent to one or more illumination wavelengths.

During operation, the illumination source 108 of FIG. 1 can output illumination 116 towards target 110. One or more wavelengths of illumination 116 can pass through regions 120 of patterned filter 112 and be reflected by reflective substrate 114 as illumination 116′. The reflected (or retroreflected) illumination 116′ can then pass through regions 120 and then through an optional imager filter 104 to be received by an imager 106. In one embodiment, the sensor 102 can then determine whether the received image (e.g., the white pattern 120 or black pattern 118 of patterned filter 112) matches an authenticated image, which may be stored. In accordance with various embodiments of the invention, the sensor 102 can access its memory 103, one or more databases 111, and/or one or more networks 109 (e.g., the Internet) for the authenticated image. If the received image associated with illumination 116′ does match an authenticated image (which may correspond to a specific product), sensor 102 can output a notification of such. For example, sensor 102 can output a message to a display device and/or an audio system indicating that target 110 has been verified as authentic.

The patterned filter 112 can be implemented with an identifier (not shown) that could be read by the user or by the imager 106 and recognized by sensor 102. The identifier could enable the user to determine whether the target label 110 has been affixed to its corresponding product or object. For example, the target label 110 can be implemented with a product number that it corresponds to.

Within FIG. 1, note that the illumination source 108 of system 100 can be implemented in a wide variety of ways. For example, the illumination source can be implemented with, but is not limited to, one or more light emitting diodes (LEDs), one or more vertical cavity surface-emitting lasers (VCSELs) with suitable diffusers if needed to widen the angle of illumination. Furthermore, when the illumination source 108 is implemented with multiple sources (e.g., LEDs and/or VCSELs) each source can output illumination at a different wavelength (e.g., visible or non-visible).

It is pointed out that sensor 102 can be implemented without illumination source 108. For example, it is possible that the ambient environment may contain sufficient light at wavelength (λ₁), thereby making the illumination source 108 unnecessary.

Within FIG. 1, it is understood that sensor 102 can be implemented in a wide variety of ways in accordance with various embodiments of the invention. For example, sensor 102 can include, but is not limited to, imager 106, illumination source 108, an address/data bus 101, memory 103, an image processor 105, an input/output (I/O) device 107, and filter 104. The sensor 102 can include address/data bus 101 for communicating information. The imager 106 can be coupled to bus 101 and imager 106 can be for collecting and outputting images to memory 103 and/or image processor 105. The image processor 105 can be coupled to bus 101 and can be for, but is not limited to, processing information and instructions, processing images, analyzing images, and/or making determinations regarding images. Note that in accordance with various embodiments (but not shown), image processor 105 can be coupled to illumination source 108. In this manner, the image processor 105 can control the operation of illumination source 108 (e.g., by turning illumination source 108 on or off). The memory 103 can be for storing software, firmware, data and/or images and can be coupled to bus 101. The I/O device 107 can be for coupling sensor 102 with external entities and can be coupled to bus 101. In one embodiment, I/O device 107 can be a modem for enabling wired and/or wireless communications between sensor 102 and an external network 109 (e.g., the Internet). Also, in one embodiment, the I/O device 107 can enable communications between sensor 102 and database 111 via network 109. Note that in one embodiment, the I/O device 107 can be communicatively coupled to database 111 without utilizing network 109.

It is understood that imager 106 can be implemented in a wide variety of ways. For example in various embodiments, imager 106 can include, but is not limited to, a charge-coupled device (CCD) imager, a complementary metal-oxide semiconductor (CMOS) imager, and the like. Additionally, memory 103 can be implemented in a wide variety of ways. For example in various embodiments, memory 103 can include, but is not limited to, volatile memory, non-volatile memory, or any combination thereof. It is understood that sensor 102 can be implemented to include more or fewer elements than those shown in system 100. Moreover, system 100 can be implemented to include more or fewer elements that those shown in FIG. 1.

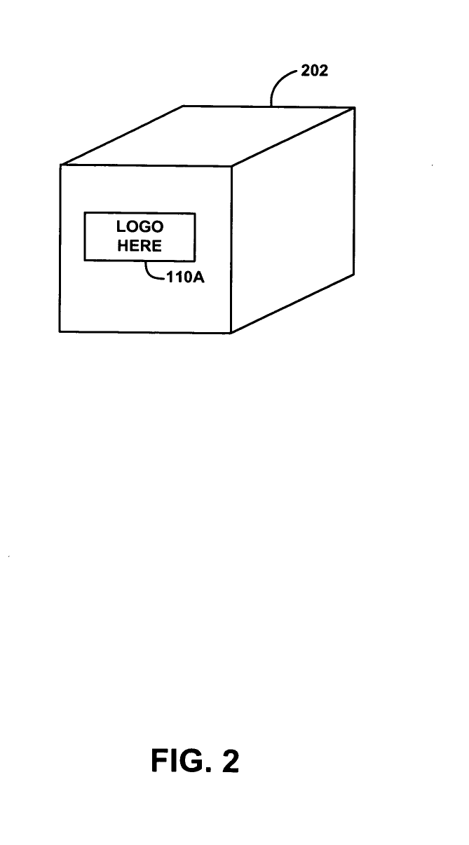

FIG. 2 is a block diagram of an exemplary product or object 202 that includes an affixed authentication target 110A in accordance with various embodiments of the invention. It is pointed out that the target label 110A shown within FIG. 2 also includes an optional covering layer that includes the writing “Logo Here”, as described herein.

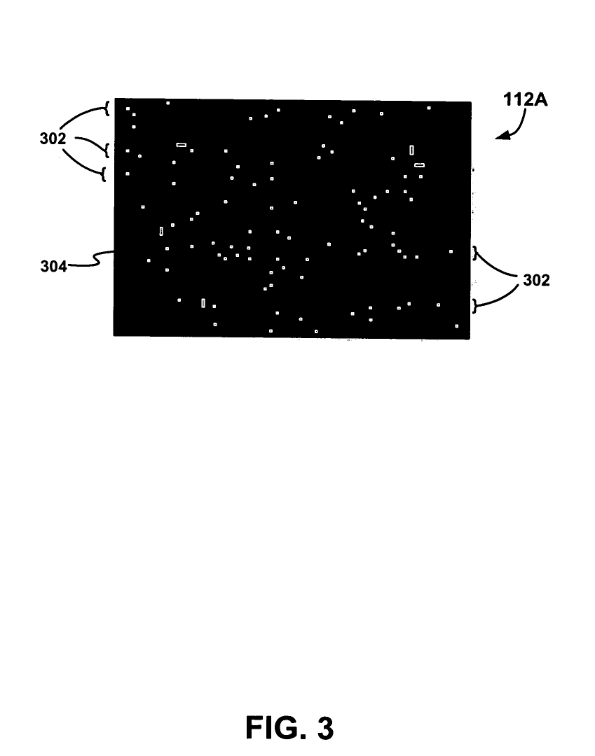

FIG. 3 is a plan view of an exemplary patterned filter 112A in accordance with various embodiments of the invention. Note that the white squares 302 shown within the patterned filter 112A are where a particular wavelength of illumination (e.g., 116) is able to pass through it while the black region 304 substantially blocks illumination of that particular wavelength, as described herein.

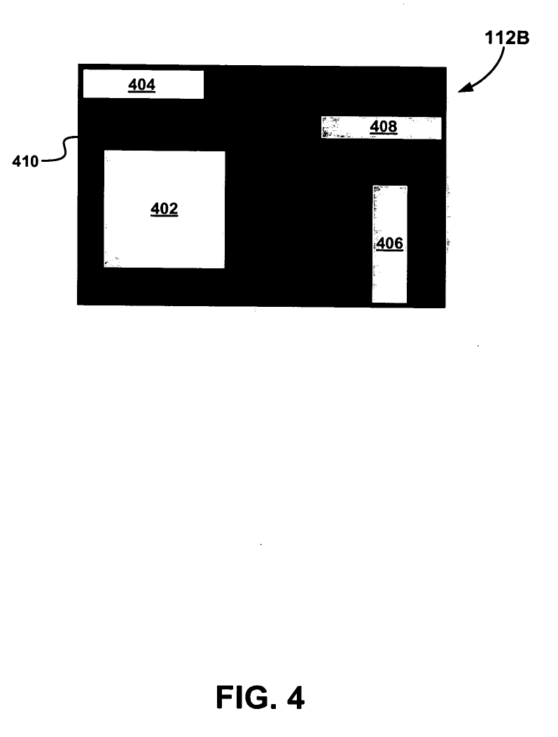

FIG. 4 is a plan view of another exemplary patterned filter 112B in accordance with various embodiments of the invention. Note that the white square 402 and rectangles 404, 406 and 408 shown within the patterned filter 112B are where a particular wavelength of illumination (e.g., 116) is able to pass through it while the black region 410 substantially blocks illumination of that particular wavelength, as described herein.

FIG. 5 is a plan view of an exemplary portion of imager filter pattern 104A in accordance with various embodiments of the invention. Specifically, the image filter pattern 104A can be implemented similar to a Bayer filter. That is, filter 104A can include red (R) square 502, green (G) square 504, and blue (B) square 506. However, instead of implementing a second G square similar to a Bayer filter, the fourth square 508 of filter 104A can be open. As such, the R 502, G 504 and B 506 squares block light at wavelength λ₁ while the clear square 508 passes wavelength λ₁ of illumination. Furthermore, the filter 104A can be utilized to determine how much of the illumination wavelength of interest the imager 106 is receiving.

FIG. 6 is a plan view of another exemplary portion of imager filter 104B in accordance with various embodiments of the invention. Specifically, the image filter pattern 104B can be implemented as a checkerboard of alternating squares that either block or pass light at wavelength λ₁. For example, blocks 602 and 608 of image filter 104B can be implemented to block illumination at wavelength λ₁ while blocks 604 and 606 can be implemented to pass illumination at wavelength λ₁. Furthermore, the filter 104B can be utilized to determine how much of the illumination wavelength of interest the imager 106 is receiving.

It is noted that there may be different patterned filters 112 on the target 110 for each wavelength, or it may be possible to combine dyes in a single patterned filter 112. The patterned filter 112 may either block selectively wherein each different wavelength filter can be presented in a side-by-side manner within a single layer or cumulatively wherein different wavelength filter layers can be “stacked vertically”, wherein one filter layer can be disposed above another filter layer and so forth. For example, in various embodiments, the selective blocking blocks can be for: wavelengths λ₁, λ₂, both or neither. Additionally, in various embodiments, the cumulative blocking blocks can be for: wavelengths λ₁, λ₂, both or neither. Note that the sensor 102 can be implemented to contain illumination sources 108 for each λ. In various embodiments, it is understood that patterned filter 112 can be implemented to block one or more wavelengths of illumination or light.

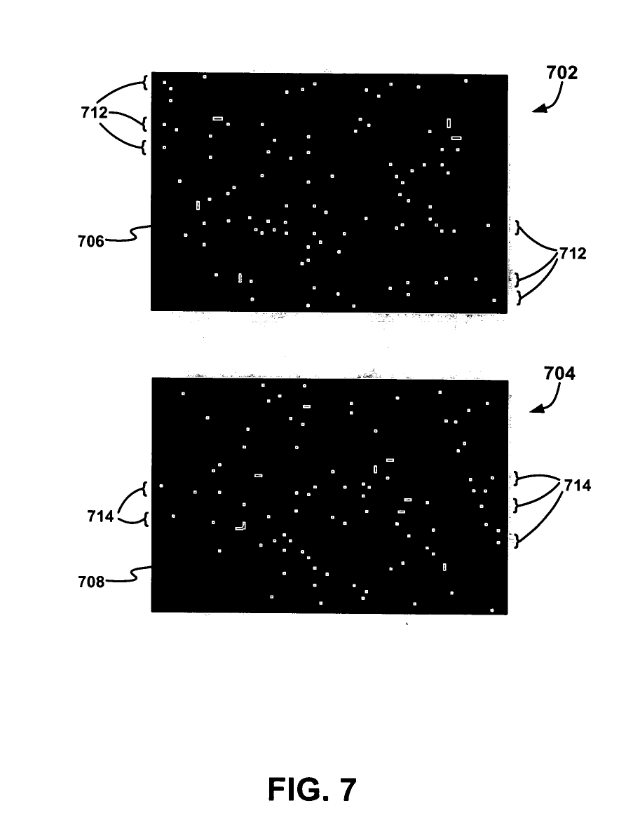

FIG. 7 is a plan view of two exemplary sequential images 702 and 704 in accordance with various embodiments of the invention. It is noted that sequential images may be acquired or received by the imager 106, with one illumination λ source 108 turned on for each image. Each image would then appear with a different pattern as shown by images 702 and 704. Note that the white squares 712 shown within the image 702 are where illumination of a particular wavelength λ₁ was able to pass through a patterned filter (e.g., 112) of a target (e.g., 110) and be reflected (or retroreflected) by its reflective substrate (e.g., 114) while the black region 706 was where that particular wavelength was substantially blocked by the patterned filter, as described herein. The reflective substrate of the target can be implemented in any manner similar to that described herein, but is not limited to such. The white squares 714 shown within the image 704 are where illumination of a different particular wavelength λ₂ was able to pass through a patterned filter of a target and be reflected (or retroreflected) by its reflective substrate while the black region 708 was where that particular wavelength was substantially blocked by the patterned filter, as described herein. Within one embodiment, some features may be present in both images to facilitate image alignment. It is appreciated that images 702 and 704 may be utilized as part of an acquisition of large targets, wherein several images are taken and combined with an image-stitching algorithm.

For example, the imager 106 may have a smaller field of view (FOV) than the entire target (or label) 110. As such, the imager 106 (or sensor 102) may be moved over the target 110, and the image-stitching algorithm will be able to stitch the pattern together and get the entire picture based on a lot of sub-images it puts together.

Note that using multiple wavelengths can be applied to tracking reflective substrate targets 110.

It is noted that with regard to various embodiments of the invention, the potentially large amount of pattern information available makes this approach very robust against misinterpretation.

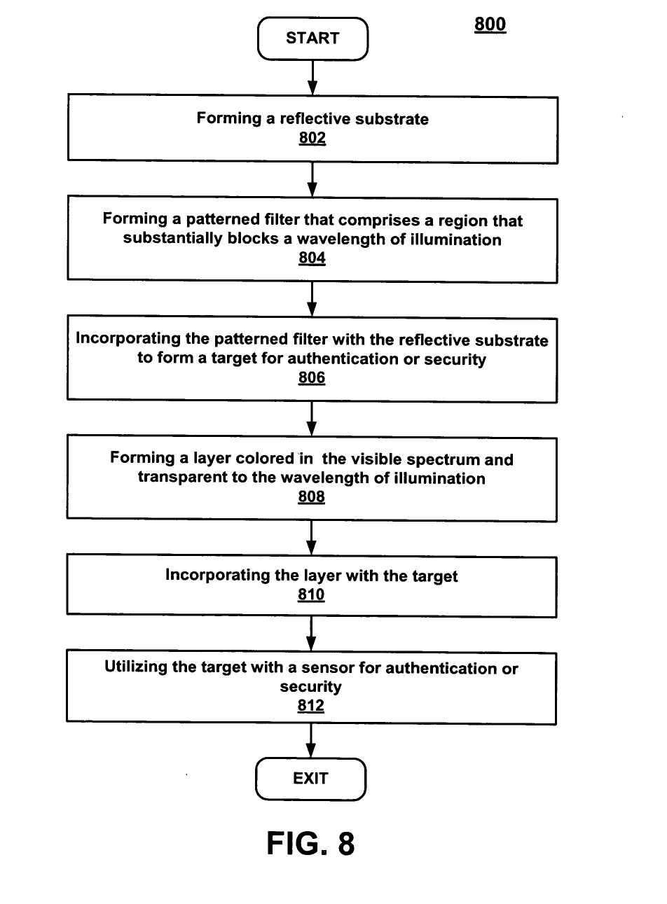

FIG. 8 is a flow diagram of a method 800 for forming and utilizing a target in accordance with various embodiments of the invention. It is appreciated that the target can be utilized for authentication and/or security. Although specific operations are disclosed in method 800, such operations are exemplary. Method 800 may not include all of the operations illustrated by FIG. 8. Also, method 800 may include various other operations and/or variations of the operations shown by FIG. 8. Likewise, the sequence of the operations of method 800 can be modified. It is noted that the operations of method 800 can be performed by software, by firmware, by electronic hardware, by fabrication tools, or by any combination thereof.

Specifically, a reflective substrate can be formed or fabricated. Additionally, a patterned filter can be formed that includes a region that substantially blocks one or more wavelengths of illumination. The patterned filter can be incorporated with the reflective substrate in order to form a target for an authentication and/or security purpose. A layer colored in the visible spectrum and transparent to a wavelength of illumination can be formed and incorporated with the target. The target can be utilized with a sensor device.

At operation 802 of FIG. 8, a reflective substrate (e.g., 114) can be formed or fabricated. It is noted that operation 802 can be implemented in a wide variety of ways. For example, the reflective substrate can be formed or fabricated at operation 802 such that it is structurally similar to any reflective substrate described herein, but is not limited to such.

At operation 804, a patterned filter (e.g., 112) can be formed that includes a region (e.g., 118) that substantially blocks one or more wavelengths of illumination (e.g., 116). Note that operation 804 can be implemented in a wide variety of ways. For example, the patterned filter can be formed such that it includes a first region (e.g., 118) that substantially blocks a wavelength of illumination and a second region (e.g., 120) that substantially allows passage of the wavelength of illumination through the patterned filter. In accordance with various embodiments of the invention, the patterned filter can be formed such that it includes a first region that substantially blocks a first wavelength of illumination, a second region that substantially blocks a second wavelength of illumination, and a third region that substantially allows passage of both the wavelengths of illumination through the patterned filter. It is appreciated that any wavelength that is being blocked can be approximately equal to a wavelength within the infrared spectrum, but is not limited to such. It is understood that operation 804 can be implemented in any manner similar to that described herein, but is not limited to such.

At operation 806 of FIG. 8, the patterned filter (e.g., 112) can be incorporated with the reflective substrate (e.g., 114) in order to form a target (e.g., 110) for an authentication and/or security purpose. It is noted that operation 806 can be implemented in a wide variety of ways. For example, the target can be formed at operation 806 such that it is structurally similar to any target described herein, but is not limited to such.

At operation 808, a layer (e.g., that may contain a pattern/design) colored in the visible spectrum and transparent to one or more wavelengths of illumination can be formed or fabricated. It is appreciated that operation 808 can be implemented in a wide variety of ways. For example, the layer can be formed or fabricated at operation 808 such that it is structurally similar to any layer having similar characteristics described herein, but is not limited to such.

At operation 810 of FIG. 8, the layer can be incorporated with the target. It is understood that operation 810 can be implemented in a wide variety of ways. For example, the layer can be incorporated with the target at operation 810 such that their combination is structurally similar to any layer and target combination described herein, but is not limited to such.

At operation 812, the target can be utilized with a sensor device or apparatus (e.g., 102). It is noted that operation 812 can be implemented in a wide variety of ways. For example, the sensor device can include one or more illumination sources (e.g., 108), and one or more imagers (e.g., 106). Additionally, each imager can be implemented with a filter (e.g., 104) that may or may not include a pattern (e.g., 104A and/or 104B). Note that the sensor device or apparatus of operation 812 can be implemented in any manner similar to that described herein, but is not limited to such. It is appreciated that operation 812 can be implemented in any manner similar to that described herein, but is not limited to such.

The foregoing descriptions of various specific embodiments in accordance with the invention have been presented for purposes of illustration and description. They are not intended to be exhaustive or to limit the invention to the precise forms disclosed, and obviously many modifications and variations are possible in light of the above teaching. The invention can be construed according to the Claims and their equivalents.

What is claimed is:

1. A sensor system comprising:
an illumination source for outputting illumination; and
an imager for receiving said illumination reflected from a target utilized for authentication, said target comprises a patterned filter and a reflective substrate.

2. The sensor system of claim 1, further comprising:
a filter utilized with said imager.

3. The sensor system of claim 1, wherein said patterned filter comprises a region that substantially blocks a wavelength of said illumination.

4. The sensor system of claim 1, wherein said reflective substrate is selected from the group consisting of a retroreflector, a substrate that substantially reflects illumination, any type of mirror, any reflective material, any reflective paint, any white colored paint, any light colored paint, any material that reflects light at a wavelength, and any material that scatters light at a wavelength.

5. The sensor system of claim 1, wherein said patterned filter comprises:
a first region that substantially blocks a first wavelength of said illumination; and
a second region that substantially blocks a second wavelength of said illumination.

6. The sensor system of claim 1, wherein said illumination source can output said illumination at substantially one wavelength.

7. The sensor system of claim 6, further comprising:
a second illumination source for outputting a second illumination at substantially a second wavelength.

8. A target apparatus comprising:
a patterned filter; and
a reflective substrate for reflecting illumination;
wherein said target apparatus can be utilized for authentication.

9. The target apparatus of claim 8, wherein said target apparatus can be affixed to an object.

10. The target apparatus of claim 8, wherein said patterned filter comprises a region that substantially blocks a wavelength of illumination.

11. The target apparatus of claim 8, wherein said patterned filter comprises:
a first region that substantially blocks a first wavelength of illumination; and
a second region that substantially blocks a second wavelength of illumination.

12. The target apparatus of claim 11, wherein:
a first image can be acquired that is associated with said first region of said patterned filter; and
a second image can be acquired that is associated with said second region of said patterned filter;
wherein said first image and said second image can be combined.

13. The target apparatus of claim 8, wherein said patterned filter comprises:
a first layer comprising a first pattern that substantially blocks a first wavelength of illumination; and
a second layer comprising a second pattern that substantially blocks a second wavelength of illumination.

14. The target apparatus of claim 8, wherein said patterned filter comprises a design colored in the visible spectrum.

15. A method comprising:
forming a reflective substrate;
forming a patterned filter that comprises a region that substantially blocks a wavelength of illumination; and
incorporating said patterned filter with said reflective substrate to form a target for authentication.

16. The method of claim 15, wherein said patterned filter further comprises:
a second region that substantially allows passage of said wavelength of illumination through said patterned filter.

17. The method of claim 15, wherein said patterned filter further comprises:
a second region that substantially blocks a second wavelength of illumination.

18. The method of claim 15, wherein said wavelength of illumination is approximately equal to an infrared wavelength.

19. The method of claim 15, further comprising:
forming a layer colored in the visible spectrum and transparent to said wavelength of illumination; and
incorporating said layer with said target.

20. The method of claim 15, further comprising:
utilizing said target with a sensor comprising:
an imager; and
an illumination source.
